(19) United States
(12) Patent Application Publication
(10) Pub. No.: US 2004/0177027 A1
(43) Pub. Date: Sep. 9, 2004

(54) Method of establishing a system of a secondary market for disbursement information

(76) Inventor: Kazuhide Adachi, Tokyo-to (JP)

Correspondence Address: GREER, BURNS & CRAIN, 300 S WACKER DR, 25TH FLOOR, CHICAGO, IL, 60606, US

(21) Appl. No.: 10/797,670

(22) Filed: Mar. 10, 2004

Related U.S. Application Data
(63) Continuation-in-part of application No. 09/811,932, filed on Mar. 19, 2001, now abandoned.

(30) Foreign Application Priority Data
Mar. 31, 2000 (JP) 2000-096611

(51) Int. Cl. G06F 17/60

(52) U.S. Cl. 705/37

(57) ABSTRACT

The present invention provides a method of establishing a system of a secondary market for disbursement information, wherein with “purchase plan information” of merchandise owned by a nation or others added with an asset value and utilized independently, purchase plan information is given to business firms that desire to utilize it, its cost being payable by buyers, as the information has an asset value. Each sample of disbursement information can be called information of a planned purchase or “Purchase Plan Information”. The purchase plan information is quantified; its value is set; it is converted to bonds, warrants or securities by fixing a common monetary unit like Yen; the purchase plan information is sold, bought or brokered at a secondary market for information; the purchase plan information is brokered at auction under appropriate conditions of the auction to facilitate its distribution; and the value of the purchase plan information is increased by using it in operations in the market for better returns.

This is a Continuation-in-Part of application Ser. No. 09/811,932, filed Mar. 19, 2001.

### FIELD OF THE INVENTION

The present invention relates to a method of establishing a system of a secondary market for disbursement information, wherein purchase plan information about merchandise that nations, businesses or individuals possess is controlled and said disbursement information is provided to businesses or individuals who need said purchase plan information.

### BACKGROUND OF THE INVENTION

Conventionally nations, businesses and individuals each have information about expenditures, which expenditures are equivalent to revenue; information about disbursements, which disbursements are equivalent to sales as shown in a statement of account; or information about spending, which spending is equivalent to annual income. The information about expenditures can be regarded as information about a possible decision for future procurement, in other words, “purchase plan information,” when viewed from its business counterpart.

For example, when a firm (nation or individual) requires a vehicle for commercial activities, that firm will order a vehicle from a car dealer. The firm will pay money for the vehicle and will take delivery of the vehicle from the car dealer. This example also applies to the case of an individual.

Conventionally, a third party would provide information about a firm's expected procurement of a vehicle to a car dealer, and in return the car dealer would give a box of candy to the third party or would provide entertainment at a certain restaurant and the like as an introduction fee. Also, the car dealer would advertise by paying a large amount of money as an advertisement fee to the mass media such as TV or newspaper companies to promote the sale of its cars and also, the dealer would pay a commission to its sales person as an incentive for sales promotion.

In other words, the firm would pay the car dealer for the vehicle procured for commercial activities, whereas the car dealer would pay a lot of various advertisement agencies a large amount of advertisement fees for sales of its cars.

In other words, both the firm and the car dealer would perform an extremely uneconomical business operation.

### SUMMARY OF THE INVENTION

The present invention provides a method of establishing a system of a secondary market for disbursement information, wherein conventional simple economic activities are eliminated. The method provides “purchase plan information” for merchandise, which is possessed by nations, businesses or individuals and which has an asset value. By controlling the information independently, businesses and individuals who want to utilize the purchase plan information buy the information, as the information has an asset value and thus is chargeable.

It is recognized that there is information available about expenditures of nations, business and individuals. A nation's expenditures are approximately equivalent to its revenue. A business has expenditures equivalent to its sales as shown in its statement of accounts. An individual has annual spending about equivalent to his annual income. This disbursement information can be called information about a possible decision for future purchases or “purchase plan information.”

The present invention is characterized in that the purchase plan information is quantified; a value of the information is set in a common monetary unit such as the Yen; the information is converted to bonds, warrants, or securities; the information is sold, bought or brokered by establishing a market for distribution of information or the information is brokered at auction under appropriate conditions of the auction to facilitate its distribution; and the value of the information is increased by using the information for operation in the market for increased returns.

A preferred embodiment is characterized in that each disbursement information or purchase plan information is quantified; a value of the information is set in a common currency unit such as Yen; the information is converted to bonds, warrants or securities; the information is sold, purchased or brokered online through the internet or the information is sold, bought, or brokered at auction under appropriate conditions of the auction to facilitate its distribution; and the value of the information is increased by using the information for operation in the market for increased returns.

Another preferred embodiment is characterized in that each of the disbursement information or purchase plan information is quantified; a value of the information is set in a common monetary unit like the Yen; the information is converted to bonds, warrants, or securities; the information is entrusted with information distribution systems, and sold, bought, brokered or used for operation through the system; the information bears interest; a bidder at auction who made a successful bid on the information under appropriate conditions of the auction is liable for payment; and the value of the information is increased by using the information for operation in the market for better returns.

This is a system that anyone can participate in once they become a member. A seller's merchandise/service can be sold to any member of this market. Once a sales transaction is completed the seller automatically becomes obliged to becoming a purchaser one day; in other words obliged to make a reciprocal purchase of some merchandise/service from a member of the market. A buyer or purchaser who buys merchandise/service from a seller gains the right to sell its merchandise to fellow members of the market. This obligation of purchase and/or right to information is converted to bonds, certificates that can be circulated in the exchange market referred to as secondary market for disbursement information or deposited with an information distribution organization to earn interest.

If “A” sells merchandise/services to “B”, “B” will be able to sell its merchandise/services to “A” or to other members of the market. Buying and selling is not just a ping-pong game restricted between “A” and “B”. There are many participants in the market that buy and sell merchandise/services and/or in turn buy and sell information. In the case of a government body the nation's budget comes from taxes (government income) and expenditures are government projects (outlay), salaries, etc. In the case of an individual a person's salary is income and expenditures are purchases, rent, etc. Information about such income and/or expenditures can be given a value and can be converted to bonds or securities.

According to information purchased, a seller of merchandise/services sells its merchandise/services to obtain a profit, normal in any sales transaction. However, if a seller were to only sell merchandise/services and a buyer only to buy merchandise/services, transactions would be one way and economic activity would be stunted. Profit would remain only in the hands of a few; the seller gaining profit from sales and the buyer continuing to buy. Therefore the described system makes it possible for a member of this disbursement market to be both a seller and a buyer, as a seller will always become a buyer and vice-versa. This is a method of creating a see-saw system of economy, one that will circulate. It's a market that anyone can join by becoming a member.

### BRIEF DESCRIPTION OF THE DRAWINGS

FIG. 1 is a disbursement flow diagram.

FIG. 2 shows that sales are equal to disbursements.

FIG. 3 shows that disbursement information is equal to purchase plan information.

FIG. 4 shows the front side of an example purchase plan information certificate.

FIG. 5 shows the back of the example purchase plan information certificate.

### DESCRIPTION OF THE PREFERRED EMBODIMENT

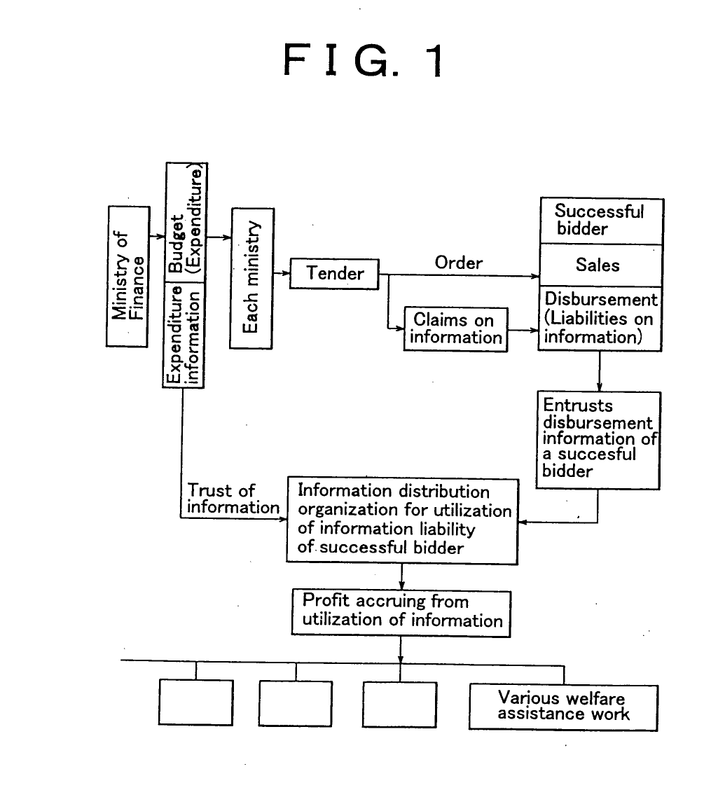

FIG. 1 shows an example relating to the present invention of a method of establishing a system of a secondary market for disbursement information. The embodiment is used to provide an explanation about a case wherein disbursement information of a nation and a successful bidder company is entrusted with the secondary information market and is used for operation in the market for better returns.

For example, where a nation intends to purchase vehicles in one lump sum for use at administration agencies of its government, the government calls for bids for the purchase, invites competitive firms to bid, and at the same time, it entrusts its expenditure information with the secondary market for information. The figure illustrates that the successful bidder entrusts its disbursement information with the secondary market for information.

In the application of the present invention,

An “information stockholder” is defined as the owner of purchase plan information, having the intention to increase its value and to utilize it by saving, investing or entrusting of the information.

“Utilization of information” is defined as utilization of purchase plan information for returns.

“Saving information” is defined as depositing purchase plan information at operating organizations for the purpose of saving.

“Interest on information” is defined as the interest accrued from utilization of purchase plan information that is deposited at information saving.

“Information investment” is defined as investment of purchase plan information at operating organizations for purchase plan information for the purpose of investment.

“Information trust” is defined as trusting of purchase plan information with operating organizations for purchase plan information.

“Information dividends” are defined as dividends on purchase plan information invested or entrusted, payable to information stockholders.

“Information claims” are defined as related to utilization of purchase plan information.

“Information liabilities” are defined as related to utilization of purchase plan information.

“Information securities” are defined as a certificate representing a right to purchase plan information, such as information claims or information liabilities.

“Information certificates” are defined as related to utilization of purchase plan information.

“Information exchange” is defined as utilization of purchase plan information in overseas transactions.

“Information management” is defined in such a way that needs, the major factor of economic activities, are interpreted as “purchase plan information” and thereby the existence of needs is perceived as the main factor of economic activities by making qualitative and quantitative approach so as to handle and utilize needs theoretically.

“Information distribution” is defined in such a way that needs are perceived as the main economic activities, and their existence is treated qualitatively, while it is quantified by fixing its unit value so as to be distributed like currency.

Since the largest enterprise is a nation both worldwide and nationwide, most of the business related to national expenditures can be assigned to the information distribution system. National expenditures, therefore, are handled through utilization of information, and a large quantity of purchase plan information corresponding to expenditures will flow into the information distribution organization from bidder companies with secondary profits resulting. FIG. 1 “Utilization of expenditure flow” illustrates the above flow. Namely, the Ministry of Finance entrusts the purchase plan information corresponding to its expenditure as information claims with the “information distribution organization for utilization of information liabilities of successful bidder companies”. The budget allocated to each ministry is used through bids, and a successful bidder company will be liable for information liability in accordance with the bid amount. The successful bidder company entrusts its own “purchase plan information” (disbursement information) with the information distribution organization, which corresponds to information liabilities in accordance with the bid amount.

The expenditure paid by the government is entrusted with the information distribution organization in the form of the “purchase plan information” (disbursement information) of the successful bidder company.

Therefore, the expenditure paid by the government is collected in the form of “purchase plan information” of the successful bidder company, and the information itself begins to have a monetary value by utilizing it at the information distribution organization, and thus it is sold or purchased independently without any involvement in other factors. The information distribution organization decides the value taking into consideration various aspects of the transaction, e.g., quantity, need, etc. Thereafter the market determines value.

The basic idea of this method is based on reciprocation. A buyer one day becomes a seller and vice-a-versa. In any transaction, there is a buyer and seller, whether an individual or government body is involved. When a buyer or successful bidder purchases X items, the right to sell is generated. When a seller sells X items, the obligation to buy arises. This is a see-saw process. It's not a flat market but a secondary market. To make the system work, certificates equivalent to the value of the information are issued and these certificates can be traded, exchanged, stored, etc.

Normally a buyer buys an item to put it to some use, perhaps to produce other items, etc. The cost of this purchase, liability information is disclosed and given a value. When X items are sold, the seller is required to disclose information about the sale. This information is also given a value, which can be stored or changed into a written bond/security. The money obtained from selling X items is not just kept but re-circulated, e.g. buying additional parts to reproduce the items or to make new ones, hiring staff, etc. With this disbursement method, the buyer and seller become interchangeable.

The method requires the successful bidder to supply information to the information distribution organization. When a government places an order, information about the government's expenditure budget for the purchase is given out to bidders at cost. When the purchase is completed, the government has an obligation to provide this purchase information. The purchase order does not include a claim on information, but a claim on some type of reciprocation. Example: X government gives out information about its intention to buy cars. Potential bidders purchase the information. Toyota becomes the successful bidder, which obligates Toyota to make a purchase preferably from X government, such as, government issued bonds, etc.

The successful bidder (the seller/e.g. Toyota) has disbursement information as to the amount of the sale to X government. The information includes liabilities information; that is the bidder's costs (labor and materials) for reproducing the goods sold for future sales or for production of new items, etc.

The successful bidder (seller/e.g. Toyota) supplies its information on the sales to the information distribution organization that places a value on the information in the form of a security certificate. The security certificate obligates Toyota into making a future purchase in some form from the purchaser. The purchaser/e.g. government now has a right to claim purchase.

The information distribution organization thus receives information security certificates of all types, purchase plan information, sales information, etc. from both the buyer/e.g. government and the supplier/e.g. successful bidder, that can be exchanged, traded, converted, etc. This action is not necessarily restricted to trade on the internet. The system, which would not work with just one or two persons carrying out transactions, revolves with a large number of participants and becomes complex and entwined.

A business firm with turnover of 10 billion Yen has disbursement information or purchase plan information in the amount of 10 billion Yen. This is a resource of disbursement information, and represents information resources available for utilization though its disbursement information assets. Also, an individual having an annual income of five million Yen has purchase plan information or disbursement information assets in the amount of five million Yen per year. Its contents include house rent, electric charges, gas charges, communication fees, commuting expenses, insurance premiums, travel expenses, food expenses, reimbursement of various loans, savings, taxes and other disbursements, and all of them are paid from the annual income of five million Yen.

It may seem that electric charges are necessary expenses to an individual without recognition of disbursement information as well as utilization capability, because there is no room for choice of payees and it is not possible for the individual to utilize the disbursement of the charges as information resources for better returns. However, electric charges paid by individuals are valuable “purchase plan information” to both electricity and gas companies, where electricity companies are competing with gas companies fiercely as to supply of generated electricity that is used for power source of refrigerators, air-conditioning units and other appliances. As regards communication fees, Nippon Telecommunications and Telephone Company customarily controlled the demand for communications with an exclusive privilege under the protection of Electricity and Communications Law. Recently, however, the law has been amended and free competition has been introduced under the pressure of advanced countries. Presently the company is granted as a communications enterprise capable of providing its own communications network. More than eight companies classified as first-rated communications enterprises are competing with each other fiercely seeking a larger share of the market.

Thus, electricity charges as well as communications charges of individuals are valuable “purchase plan information” to production enterprises. All other disbursements such as insurance premiums, traveling expenses, wedding and funeral expenses, savings, taxes and other disbursements are “purchase plan information”, and therefore the disbursement information that is directly related to sales for business firms.

Although purchase plan information is directly related to sales for business firms, the present economic system has neither the concept nor organization to positively recognize and receive purchase plan information to increase value in its utilization. For example, while someone is planning to purchase a car that will costs him/her two million yen, car manufacturers are spending an enormous amount of money for advertisements to look for purchasers or customers. However, there is no economic system for all to deposit and utilize the “purchase plan information” of the potential purchaser.

If you visit the counter of a bank or post office, clerks there are willing to accept your saving money. However, if you come to the counter of a bank or post office with purchase plan information that has two thousand times the value of the above saving money and ask for better returns, the present system does not allow the bank or post office to accept this type of request to use for better returns.

Since the main object of economic activities has been directed to pursuit of profits only, the concept of management of information about needs that is the main inducement of production, has not been recognized at all.

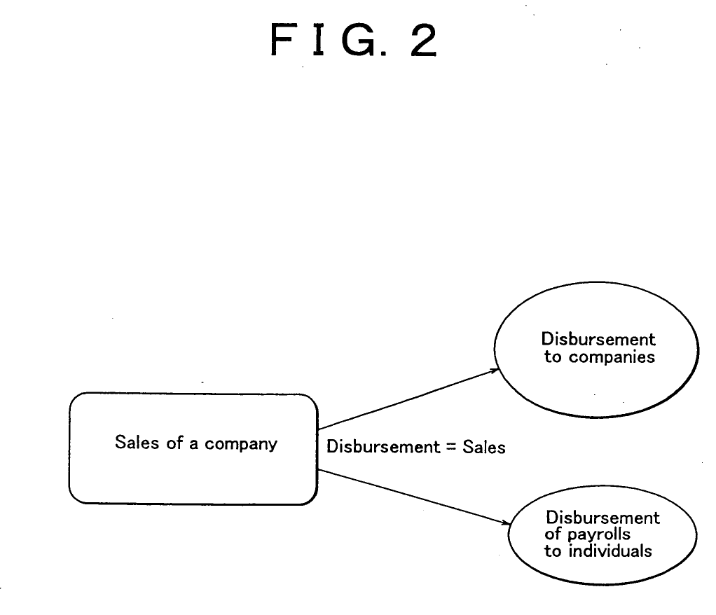

As illustrated in FIG. 2, sales by enterprises consist of disbursement of other firms or individuals.

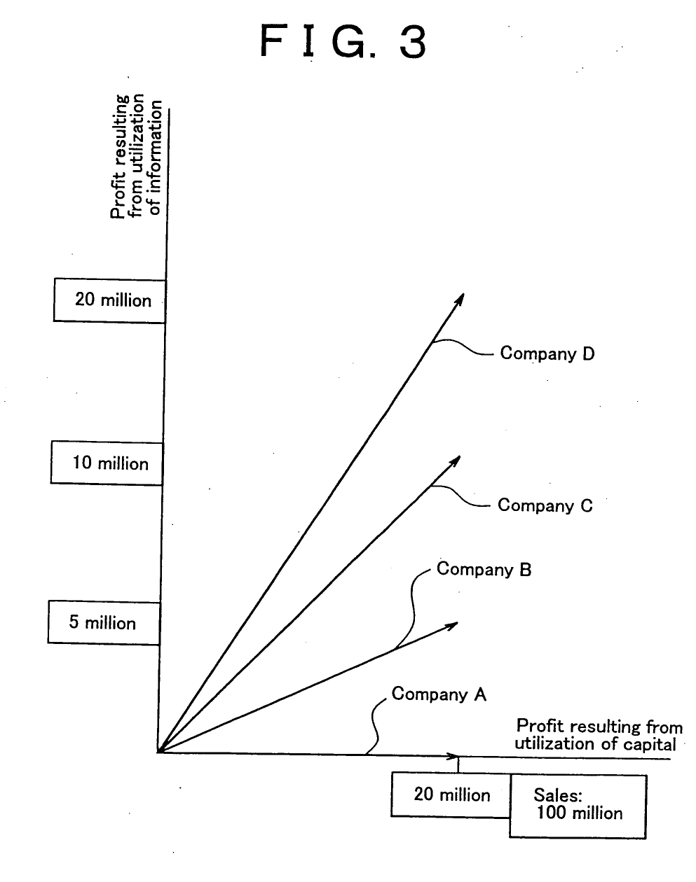

For example, as illustrated in FIG. 3, let us assume that there are four companies A, B, C and D, each having sales of 100 million Yen and a profit of 20 million Yen according to each statement of accounts. Company A does not utilize “purchase plan information” or disbursement information assets at all, whereas company B utilizes “purchase plan information” resulting in a profit of nine million Yen accruing; company C utilizes “purchase plan information” resulting in a profit of ten million Yen accruing; company D utilizes “purchase plan information” resulting in a profit of twenty million Yen accruing.

Namely,

Company A's profit: 20 million

Company B's profit: 20 million+5 million=25 million

Company C's profit: 20 million+10 million=30 million

Company D's profit: 20 million+20 million=40 million

Based only on the evaluation of the statement of accounts of each company, each company A, B, C or D records sales of 100 million and a profit of 20 million, whereas a differential in actual profit between company A and company D reaches as high as two times due to utilization of the disbursement information.

A large amount of profit accrues at enterprises who know about disbursement information assets (purchase plan information) equivalent to sales by managing these assets properly.

With the abscissa (X-axis) representing profits accruing from sales and the ordinate (Y-axis) representing profits accruing from disbursement information assets, various characteristic curves on the coordinate provide useful data in that management capabilities of enterprises can be evaluated precisely.

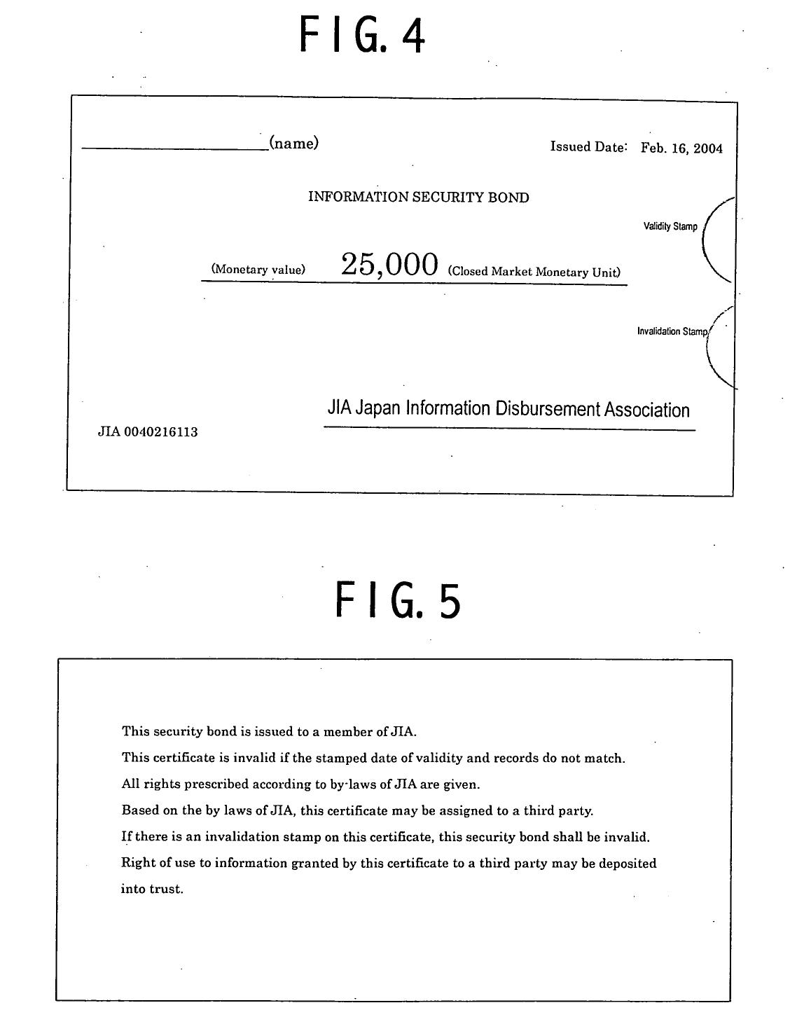

FIGS. 4 and 5 illustrate, respectively, the front and back sides of an example purchase plan information certificate. It should be noted that this is just one example. The security, bond or warrant certificate may take any commercially acceptable form, either tangible or electronic. The example certificate has in identification number “JIA 0040216113,” provides an initial set value of “25,000” Yen (closed market monetary units), and entitles the holder to particular purchase plan information, which is not specifically identified on the face of the certificate in this example.

The method of establishing a system of a secondary market for disbursement information of the present invention provides excellent effects in that disbursement information or purchase plan information is quantified; the information is converted to bonds, warrants, or securities; the information is entrusted with information distribution systems wherein the information is sold, purchased, brokered, or bears interest; a bidder at auction who made a successful bid on the information is liable for disbursement; and thereby a secondary market or cyber market for disbursement can be established, wherein distribution of the information is promoted with its value increased and the information is utilized for operation at the market to improve returns.

The method of establishing a system of a secondary market for disbursement information of the present invention provides excellent effects in that the information itself begins to have a monetary value by utilizing it at the information distribution organization, and thus it is sold or purchased independently without any involvement in other factors.

What is claimed is:

1. A method of establishing a system of a secondary market for disbursement information characterized in that said disbursement information reflecting expenditures represents information about expected purchases or purchase plan information; said purchase plan information is quantified; the value of said purchase plan information is set in a common monetary unit; said purchase plan information is converted to bonds, warrants, or securities, said bonds, warrants or securities comprising the right to receive said purchase plan information; said purchase plan information is sold, bought or brokered at a secondary market provided for information; said purchase plan information is brokered at auction under appropriate conditions of the auction to facilitate its distribution; and the value of said purchase plan information is increased by using said information for operation in said market for better returns.

2. A method as in claim 1 wherein said secondary market for information comprises an online internet auction.

3. A method of establishing a system of a secondary market for disbursement information characterized in that information about spending represents purchase plan information; said purchase plan information is quantified; a value for said purchase plan information is set in a common monetary unit; said purchase plan information is converted to bonds, warrants, or securities said bonds, stocks or securities comprising a right to purchase plan information; said purchase plan information is entrusted with an information distribution system and is sold, bought, brokered or used for operation through said system; said purchase plan information bears interest; a bidder at auction who has made a successful bid on said purchase plan information is liable for payment; and the value of said purchase plan information is increased by using said information for operation in said market for better returns.

4. A method of establishing a secondary market for disbursement information of nations, businesses and individuals comprising,
quantifying the disbursement information in monetary units as purchase plan information;
converting the purchase plan information to bonds, warrants or securities, said bonds, warrants or securities representing a right to the purchase plan information;
entrusting the purchase plan information bonds, warrants or securities with an information distribution system wherein purchase plan information is sold, purchased, brokered, or bears interest; and
auctioning purchase plan information in the information distribution system. thereby establishing a secondary market for disbursement information, to increase its value and improve returns.

5. A method as in claim 4 wherein said information distribution system is the internet.

6. A method as in claim 4, wherein at least one firm provides goods or services to at least one of said nations, businesses and individuals, said firm having its own disbursement information that corresponds to the goods or services provided to said at least one of the nations, businesses and individuals, and further comprising the steps of
quantifying the firm's disbursement information in monetary units as purchase plan information;
converting the firm's purchase plan information to bonds, warrants or securities, said bonds, warrants or securities representing a right to the firm's purchase plan information; and
entrusting the firm's purchase plan information bonds, warrants or securities with said information distribution system wherein purchase plan information is sold, purchased, brokered, or bears interest.
